(19) United States
(12) Patent Application Publication
(10) Pub. No.: US 2021/0270548 A1
(43) Pub. Date: Sep. 2, 2021

(54) HEAT EXCHANGER

(71) Applicant: DENSO CORPORATION, Kariya-city (JP)

(72) Inventors: Kazutaka SUZUKI, Kariya-city (JP); Taichi ASANO, Kariya-city (JP); Shota TERACHI, Kariya-city (JP); Akira HIRANO, Kariya-city (JP)

(73) Assignee: DENSO CORPORATION, Kariya-city (JP)

(21) Appl. No.: 17/322,551

(22) Filed: May 17, 2021

Related U.S. Application Data
(63) Continuation of application No. PCT/JP2019/043485, filed on Nov. 6, 2019.

(30) Foreign Application Priority Data
Nov. 20, 2018 (JP) 2018-217485

(51) Int. Cl. F28F 9/18; F28F 9/00; F28D 9/00; B23K 1/00

(52) U.S. Cl. CPC F28F 9/18; F28F 9/001; F28F 2275/04; B23K 1/0012; F28D 9/005

(57) ABSTRACT

A heat exchanger includes a plate member, a fixation member, and a brazing material pathway. The plate member has a first side coated with a brazing material, and a second side which is an opposite side of the first side and is not coated with the brazing material. The fixation member is disposed on the second side and configured to fix a position of a pipe. The brazing material pathway extends from the first side to the second side. The brazing material coated on the plate member spreads into the brazing material pathway. The pipe is inserted into an insertion hole formed in the plate member. An entire outer circumference of the pipe is swaged and engaged with an inner side of the insertion hole. The brazing material pathway is formed on at least the outer circumference of the pipe or the inner side of the insertion hole.

### CROSS REFERENCE TO RELATED APPLICATION

The present application is a continuation application of International Patent Application No. PCT/JP2019/043485 filed on Nov. 6, 2019, which designated the U.S. and claims the benefit of priority from Japanese Patent Application No. 2018-217485 filed on Nov. 20, 2018. The entire disclosures of all of the above applications are incorporated herein by reference.

### TECHNICAL FIELD

The present disclosure relates to a heat exchanger.

### BACKGROUND

A conventional heat exchanger includes multiple cooling plates stacked with each other, and a duct plate that surrounds the stacked cooling plates. Each cooling plate defines therein a coolant passage through which coolant flows. Supercharged air of a vehicle flows into the duct plate. The supercharged air flowing through the duct plate flows outside the cooling plates. In the heat exchanger, the supercharged air is cooled by heat exchange between the coolant flowing through the inside of the cooling plates and the supercharged air flowing through the inside of the duct plate.

In the heat exchanger, an inflow pipe through which the coolant flows into the heat exchanger and an outflow pipe through which the coolant flows out of the heat exchanger are provided on an upper surface of the duct plate. An end portion of the inflow pipe is inserted into an insertion hole formed in the upper surface of the duct plate. The end portion of the inflow pipe has a rib protruding from an outer circumference of the end portion of the inflow pipe. The inflow pipe is fixed to the duct plate by joining the rib to the upper surface of the duct plate. The outflow pipe is fixed to the upper surface of the duct plate in the same manner as the inflow pipe.

### SUMMARY

A heat exchanger according to an aspect of the present disclosure includes a plate member, a fixation member, and a brazing material pathway. The plate member has a first side coated with a brazing material, and a second side which is an opposite side of the first side and is not coated with the brazing material. The fixation member is disposed on the second side and configured to fix a position of a pipe. The brazing material pathway extends from the first side to the second side. The brazing material coated on the plate member spreads into the brazing material pathway. The pipe is inserted into an insertion hole formed in the plate member. An entire outer circumference of the pipe is swaged and engaged with an inner side of the insertion hole. The brazing material pathway is formed on at least the outer circumference of the pipe or the inner side of the insertion hole.

### BRIEF DESCRIPTION OF THE DRAWINGS

FIG. 1 is a block diagram illustrating an air intake system of a vehicle on which a heat exchanger according to at least one embodiment of the present disclosure is mounted.

FIG. 2 is a plan view illustrating a structure of the heat exchanger according to at least one embodiment of the present disclosure.

FIG. 3 is a side view illustrating a structure of a heat exchange portion of the heat exchanger according to at least one embodiment of the present disclosure.

FIG. 4 is a cross-sectional view taken along a line IV-IV of FIG. 2.

FIG. 5 is a lower view of a joint portion of a duct plate and an inflow pipe of the heat exchanger according to at least one embodiment of the present disclosure.

FIG. 6 is a cross-sectional diagram showing a manufacturing step for bonding the duct plate and the inflow pipe of the heat exchanger according to at least one embodiment of the present disclosure.

FIG. 7 is a lower view of the joint portion of the duct plate and the inflow pipe of the heat exchanger according to at least one embodiment of the present disclosure.

FIG. 8 is a cross-sectional diagram illustrating an example of a flow of a brazing material around the joint portion of the insertion hole of the duct plate and the inflow pipe of the heat exchanger according to at least one embodiment of the present disclosure.

FIG. 9 is a cross-sectional diagram illustrating a structure around the joint portion of the insertion hole of the duct plate and the inflow pipe of the heat exchanger according to at least one embodiment of the present disclosure.

FIG. 10 is a cross-sectional diagram illustrating a structure around the joint portion of the insertion hole of the duct plate and the inflow pipe of the heat exchanger according to at least one embodiment of the present disclosure.

FIG. 11 is a cross-sectional diagram illustrating a structure around the joint portion of the insertion hole of the duct plate and the inflow pipe of the heat exchanger according to at least one embodiment of the present disclosure.

FIG. 12 is a cross-sectional diagram illustrating a structure around the joint portion of the insertion hole of the duct plate and the inflow pipe of the heat exchanger according to at least one embodiment of the present disclosure.

FIG. 13 is a cross-sectional diagram illustrating a structure around the joint portion of the insertion hole of the duct plate and the inflow pipe of the heat exchanger according to at least one embodiment of the present disclosure.

FIG. 14 is a lower view of a joint portion of an inflow pipe of a duct plate and an inflow pipe of the heat exchanger according to at least one embodiment of the present disclosure.

FIG. 15 is a diagram showing a manufacturing step for bonding the duct plate and the inflow pipe of the heat exchanger according to at least one embodiment of the present disclosure.

FIG. 16 is a diagram showing a manufacturing step for bonding the duct plate and the inflow pipe of the heat exchanger according to at least one embodiment of the present disclosure.

### EMBODIMENTS

### Comparative Example

According to a heat exchanger of a comparative example, parts are brazed to each other. Specifically, after the parts of the heat exchanger which are coated with brazing material are assembled using jigs, the assembled product is put into a furnace and heated to melt the brazing material coated on the parts. Subsequently, the brazing material is solidified by taking out the assembled product and cooling it, and accordingly the parts are bonded to each other.

In the heat exchanger of the comparative example, a rib of a pipe is joined to an upper surface of a duct plate. According to this structure, it may be necessary to coat the upper surface of the duct plate with the brazing material. In such structure, the jigs used during brazing may touch the brazing material coated on the upper surface of the duct plate. When the jigs touch the brazing material coated on the upper surface of the duct plate, the touched part may be interfered with the jigs during the brazing step, and accordingly appearance defects may occur. Hereinafter, an embodiment of a heat exchanger will be described with reference to the drawings. To facilitate understanding, identical constituent elements are designated with identical symbols in the drawings where possible with the duplicate description omitted.

### First Embodiment

First, an outline of an air intake system of a vehicle on which a heat exchanger or the present embodiment is mounted will be described.

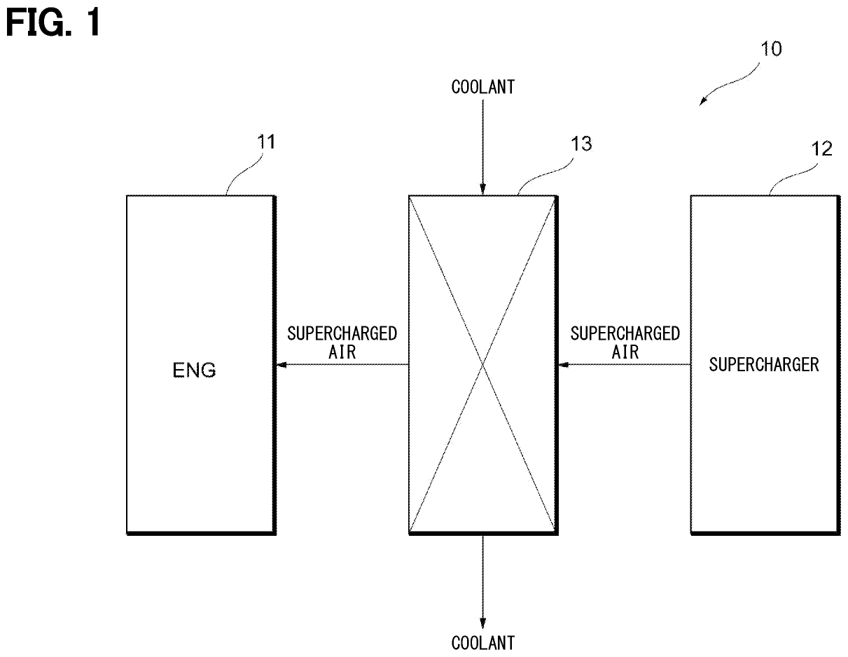

As shown in FIG. 1, an air intake system 10 of the vehicle is provided with a supercharger 12 for supercharging air to be taken into an engine 11. The heat exchanger 13 is disposed between the engine 11 and the supercharger 12. The heat exchanger 13 performs heat exchange between the air supercharged by the supercharger 12 and coolant to cool the supercharged air and supply the cooled air to the engine 11. As a result, charging efficiency of the air supplied to the engine 11 is increased, and the output of the engine 11 can be increased. In the present embodiment, the supercharged air corresponds to a first fluid, and the coolant corresponds to a second fluid.

Next, a structure of the heat exchanger 13 will be specifically described.

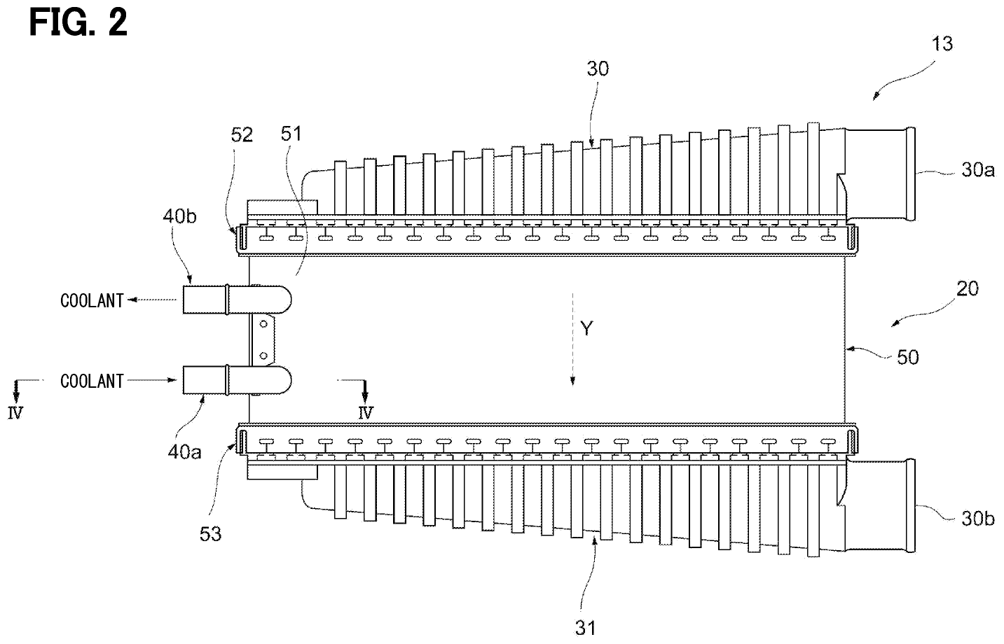

As shown in FIG. 2, the heat exchanger 13 includes a heat exchange portion 20, tanks 30, 31, and pipes 40a, 40b. The heat exchanger 13 is made of a metal material such as an aluminum alloy.

The heat exchange portion 20 has a substantially rectangular parallelepiped shape. The heat exchange portion 20 includes a duct plate 50, an inflow side crimping plate 52, and an outflow side crimping plate 53. In the present embodiment, the duct plate 50 corresponds to a plate member.

The duct plate 50 has a quadrilateral cylinder shape. The inflow side crimping plate 52 that has a quadrilateral annular shape is brazed to a periphery of an opening portion on a first side of the duct plate 50. An opening portion on a first side of an inflow tank 30 which has a quadrilateral cylinder shape is fixed to the inflow side crimping plate 52 by crimping the inflow side crimping plate 52. The outflow side crimping plate 53 that has a quadrilateral annular shape is brazed to a periphery of an opening portion on a second side of the duct plate 50. An opening portion on a first side of an outflow tank 31 which has a quadrilateral cylinder shape is fixed to the outflow side crimping plate 53 by crimping the outflow side crimping plate 53.

An inflow pipe 40a through which the coolant flows into the heat exchange portion 20 and an outflow pipe 40b through which the coolant flows out of the heat exchange portion 20 are provided on an outer wall portion 51 of the duct plate 50.

The supercharged air flows into the inflow tank 30 of the heat exchanger 13 through a pipe connected to a second side end portion 30a of the inflow tank 30. The supercharged air flowing into the inflow tank 30 from the second side end portion 30a flows through an inside of the duct plate 50 in a direction represented by an arrow Y. The supercharged air flowing out of the duct plate 50 is discharged to a pipe connected to a second side end portion 31a of the outflow tank 31 through the outflow tank 31.

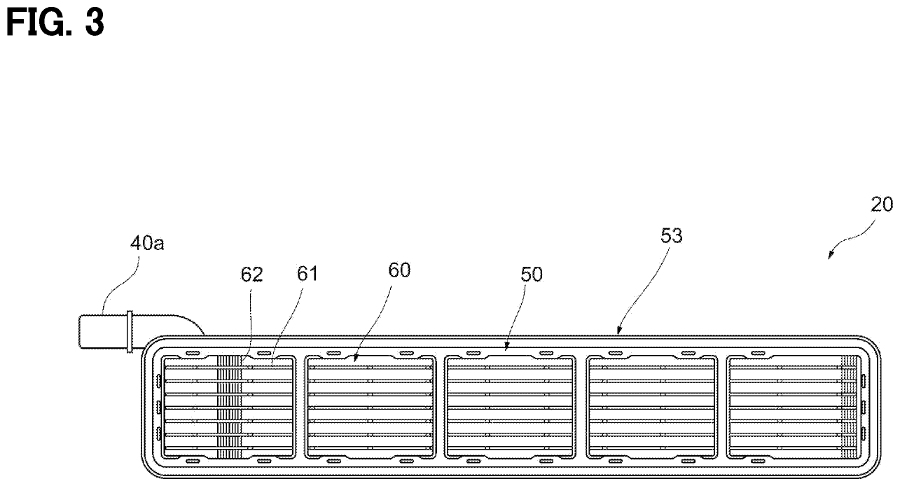

As shown in FIG. 3, the heat exchanger 20 includes a heat exchanger core 60 accommodated in the duct plate 50. The heat exchanger core 60 actually performs heat exchange between the supercharged air and the coolant. The heat exchanger core 60 includes multiple cooling plates 61 and multiple outer fins.

The cooling plates 61 are stacked with each other and spaced from each other by predetermined intervals. Outer peripheries of a pair of plate members are joined to each other to form the cooling plate 61. An inner space of each of the cooling plate 61 is a coolant passage through which the coolant flows. The coolant passages in the cooling plates 61 communicate with each other. The coolant passage in each cooling plate 61 communicates with the inflow pipe 40a and the outflow pipe 40b shown in FIG. 2. A gap is formed between adjacent cooling plates 61. The supercharged air in the duct plate 50 flows through the gap.

The outer fin 62 is disposed in the gap between adjacent cooling plates 61. The outer fin 62 increases a heat transfer area of the cooling plate 61 to the supercharged air, and thereby the heat exchange capacity of the heat exchanger 13 is increased.

In the heat exchanger 13, the coolant flowing from the inflow pipe 40a is distributed to the coolant passages in the cooling plates 61. The coolant exchanges heat with the supercharged air flowing outside the cooling plates 61 while the coolant flows through the cooling passages in the cooling plates 61, and thereby the coolant absorbs heat of the supercharged air. The supercharged air is cooled as a result. The coolant whose temperature increased due to the heat of the supercharged air is discharged through the outflow pipe 40b.

Next, a structure of joint portions at which the pipes 40a, 40b are joined to the duct plate 50. Since the structure of the joint portions at which the pipes 40a, 40b are connected to the duct plate 50 are the same, only the structure of the joint portion at which the inflow pipe 40a is connected to the duct plate 50 will be described below.

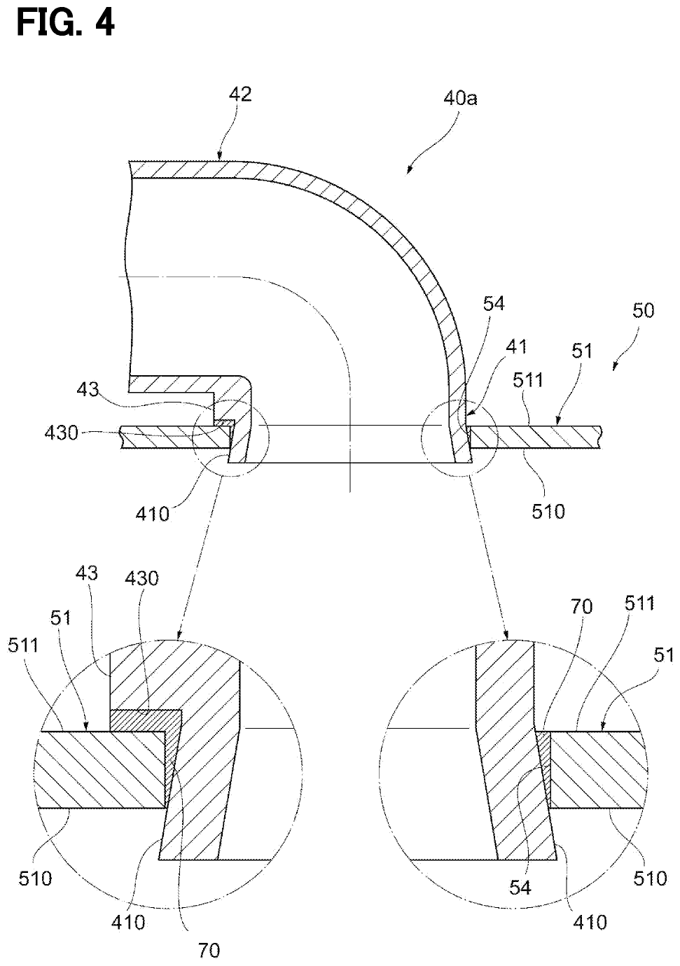

As shown in FIG. 4, the outer wall portion 51 of the duct plate 50 has an insertion hole 54 into which the inflow pipe 40a is inserted. No burring is formed at the insertion hole 54. An inner surface 510, which is one side of the outer wall portion 51 of the duct plate 50, is coated with a brazing material. An outer surface 511, which is the opposite side of the inner surface 510 of the outer wall portion 51, is not coated with the brazing material.

The inflow pipe 40a has a substantially L-shape. The inflow pipe 40a includes a first portion 41 that extends along a direction perpendicular to the outer surface 511 of the outer wall portion 51 of the duct plate 50, and a second portion 42 that extends from an end of the first portion 41 in parallel with the outer surface 511 of the outer wall portion 51 of the duct plate 50. An end portion 410 of the first portion 41 of the inflow pipe 40a is widened all around. Accordingly, an entire outer circumference of the end portion 410 of the inflow pipe 40a is engaged with an inner side of the insertion hole 54.

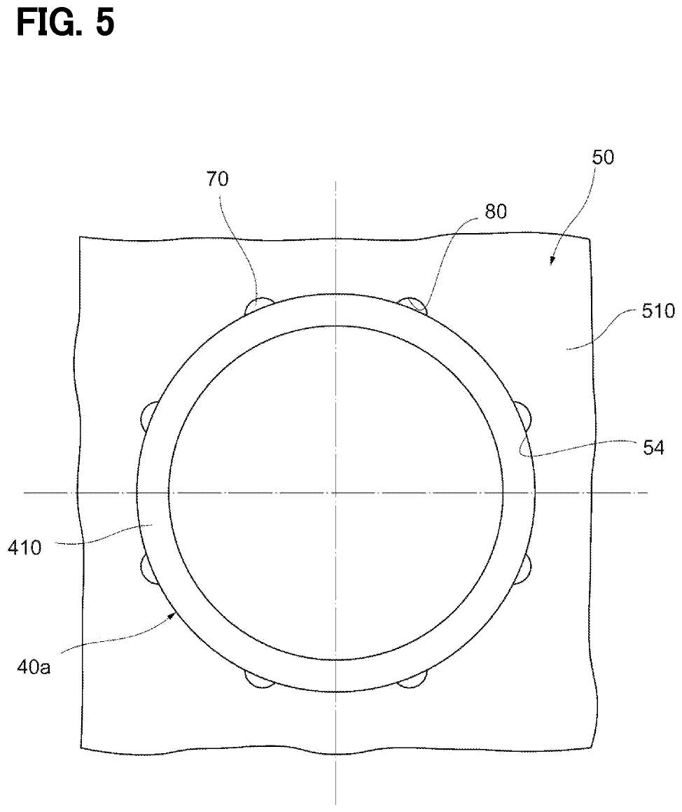

As shown in FIG. 5, the inner side of the insertion hole 54 of the duct plate 50 is notched to have blazing material pathways 80 each of which has a semicircular shape in its cross-section. The brazing material pathway 80 extends from the inner surface 510 to the outer surface 511 of the duct plate 50 shown in FIG. 4. As shown in FIG. 5, the brazing material pathway 80 is not closed even when the entire circumference of the end portion 410 of the inflow pipe 40a is in contact with the inner side of the insertion hole 54 of the duct plate 50. Accordingly, the brazing material coated on the inner surface 510 of the duct plate 50 may flow through the brazing material pathways 80 to the outer surface 511 of the outer wall portion 51 of the duct plate 50 shown in FIG. 4.

As enlarged in FIG. 4, the brazing material 70 flows through the brazing material pathways 80 into a gap between the outer circumference of the end portion 410 of the inflow pipe 40a and the inner side of the insertion hole 54 of the duct plate 50, and thereby the gap is filled with the brazing material 70. The inflow pipe 40a and the duct plate 50 are joined with each other by the brazing material 70.

The first portion 41 of the inflow pipe 40a has a protrusion portion 43 that protrudes from the outer circumference of the first portion 41. The protrusion portion 43 is formed at a part of the outer circumference of the first portion 41 of the inflow pipe 40a facing the direction along which the second portion 42 extends. The brazing material 70 flows through the brazing material pathway 80 into a gap between a bottom surface 430 of the protrusion portion 43 and the outer surface 511 of the outer wall portion 51 of the duct plate 50, and thereby the gap is filled with the brazing material 70. The inflow pipe 40a is bonded to the duct plate 50 by the brazing material 70.

Next, a method of joining the inflow pipe 40a to the insertion hole 54 of the duct plate 50 will be described.

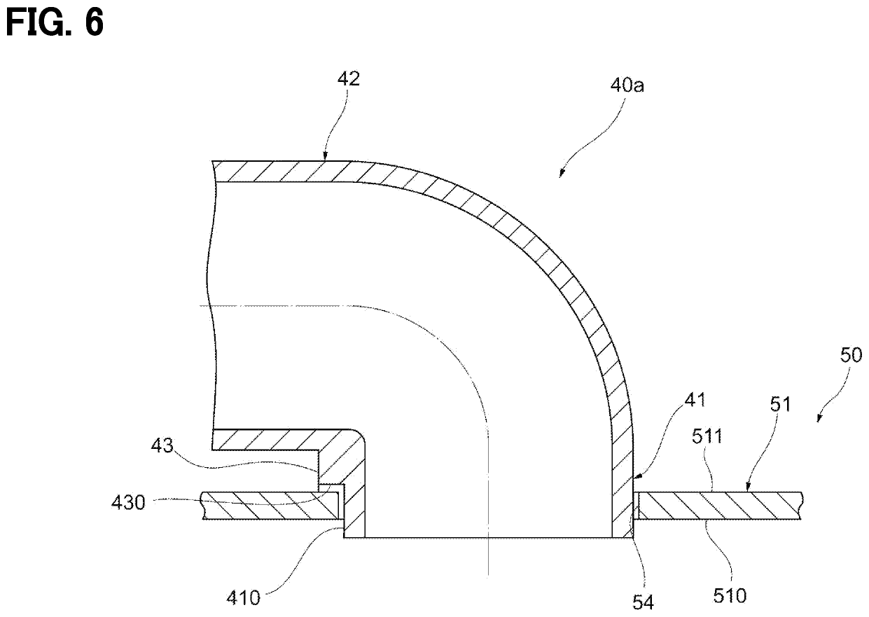

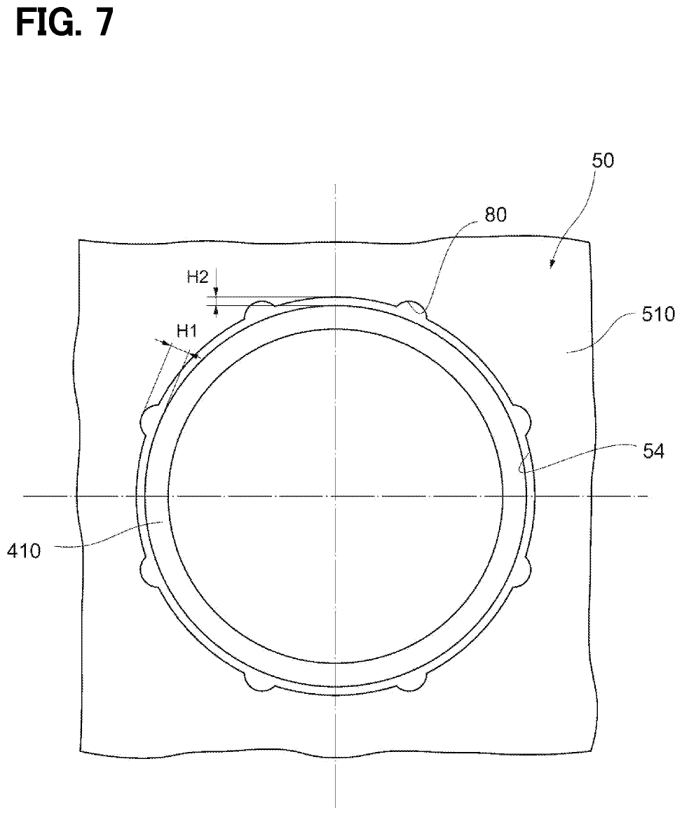

As shown in FIGS. 6, 7, in a condition where the inflow pipe 40a has not joined to the duct plate 50, an outer diameter of the end portion 410 of the inflow pipe 40a is smaller than an inner diameter of the insertion hole 54 of the duct plate 50. Accordingly, the end portion 410 of the inflow pipe 40a can be inserted into the insertion hole 54 of the duct plate 50.

As shown in FIG. 6, in an assembling step in which each component of the heat exchanger 13 are assembled, the end portion 410 of the inflow pipe 40a is inserted into the insertion hole 54 of the duct plate 50. At this time, the bottom surface 430 of the protrusion portion 43 of the inflow pipe 40a comes into contact with the outer surface 511 of the outer wall portion 51 of the duct plate 50, and thereby the position of the second portion 42 of the inflow pipe 40a relative to the outer surface 511 of the outer wall portion 51 of the duct plate 50 can be settled. In the present embodiment, the protrusion portion 43 of the inflow pipe 40a works as a positioning member.

In the assembling step, the end portion 410 of the inflow pipe 40a is swaged, and thereby the entire outer circumference of the end portion 410 of the inflow pipe 40a is engaged to the inner side of the insertion hole 54 of the duct plate 50. Accordingly, the inflow pipe 40a is temporarily fixed to the duct plate 50.

Subsequent to the assembling step, a bonding step of bonding the parts of the heat exchanger 13 together by brazing is performed. In the bonding step, the parts are held in an assembled state by attaching appropriate jigs to the assembled product. Subsequently, the assembled product to which the jigs are attached is put into a furnace and is heated to melt the brazing material coated on the surface of the parts. As a result, the brazing material spreads and flows into joint portions of the parts.

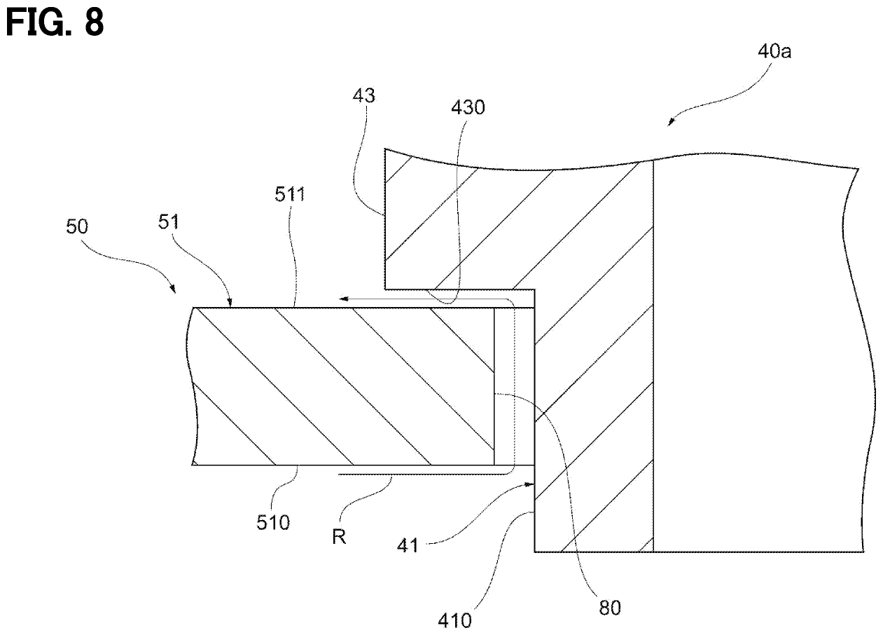

At this time, as represented by an arrow R in FIG. 8, the brazing material coated on the inner surface 510 of the outer wall portion 51 of the duct plate 50 flows into the brazing material pathway 80. Due to capillary action, the brazing material flowing into the brazing material pathways 80 flows into the gap between the outer circumference of the end portion 410 of the inflow pipe 40a and the inner side of the insertion hole 54 of the duct plate 50, and the gap between the bottom surface 430 of the protrusion portion 43 of the inflow pipe 40a and the outer surface 511 of the outer wall portion 51 of the duct plate 50.

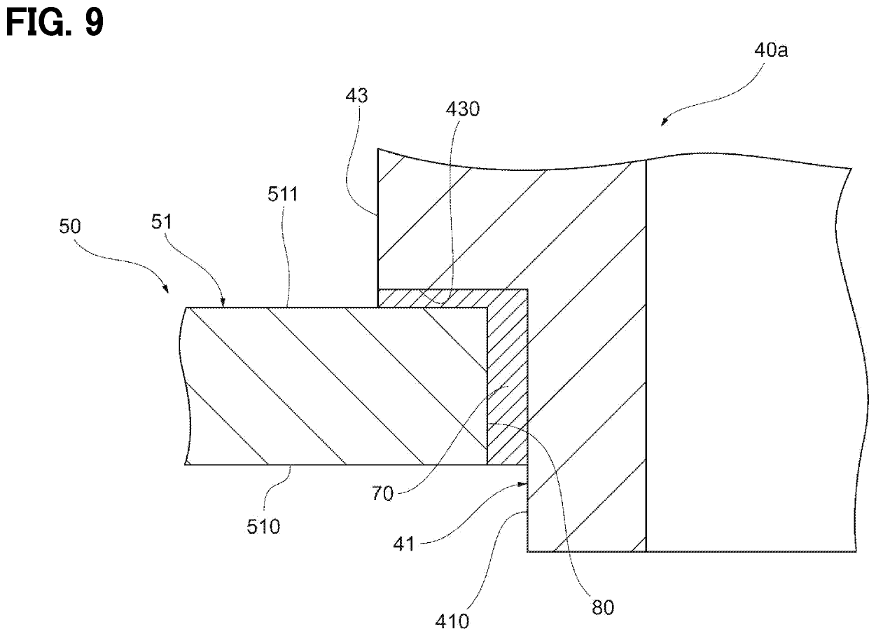

Subsequently, the parts of the heat exchanger 13 are bonded together by cooling the assembled product after taking out the assembled product from the furnace. As shown in FIG. 9, the brazing material 70 flowing into the brazing material pathways 80 and the gap between the bottom surface 430 of the protrusion portion 43 of the inflow pipe 40a and the outer surface 511 of the outer wall portion 51 of the duct plate 50 solidifies. Similarly, the brazing material flowing into the gap between the outer circumference of the end portion 410 of the inflow pipe 40a and the inner side of the insertion hole 54 of the duct plate 50 solidifies. As a result, the inflow pipe 40a and the duct plate 50 are joined with each other by the brazing material 70.

According to the heat exchanger 13 of the present embodiment described above, operations and effects described in the following items (1) to (5) can be obtained.

(1) The heat exchanger 13 includes a duct plate 50 having a first side coated with the brazing material and a second side that is the opposite side of the first side and is not coated with the brazing material. The protrusion portion 43 that is a fixation member for the inflow pipe 40a is in contact with the second side of the duct plate 50. The heat exchanger 13 includes the brazing material pathway 80 extending through the duct plate 50 from the inner surface 510 of the duct plate 50 that is coated with the brazing material to the outer surface 511 that is not coated with the brazing material. The brazing material pathway 80 is defined between the inner side of the insertion hole 54 of the duct plate 50 and the outer circumference of the inflow pipe 40a. The brazing material pathway 80 extends from the inner surface 510 to the outer surface 511 of the duct plate 50. The brazing material coated on the inner surface 510 of the outer wall portion 51 of the duct plate 50 flows into the brazing material pathway 80. According to this, the duct plate 50 and the inflow pipe 40a can be bonded to each other by the brazing material flowing into the brazing material pathway 80. Since the brazing material 70 is coated on the inner surface 510 of the outer wall portion 51 of the duct plate 50, the brazing material 70 would not contact the jigs used when the parts of the heat exchanger 13 are brazed with each other. Accordingly, occurrence of appearance defects can be suppressed.
(2) The brazing material pathway 80 is formed on the inner side of the insertion hole 54 of the duct plate 50. According to this configuration, the brazing material pathway 80 can be easily formed just by processing the inner side of the insertion hole 54 of the duct plate 50.
(3) As shown in FIG. 7, a width H1 of the brazing material pathway 80 is greater than a width H2 of the gap defined between the inner side of the insertion hole 54 of the duct plate 50 and the outer circumference of the inflow pipe 40a. According to this configuration, the brazing material easily flows into the brazing material pathway 80.
(4) The entire circumference of the inflow pipe 40a is engaged with the inner side of the insertion hole 54 of the duct plate 50. The brazing material pathway 80 is formed on the inner side of the insertion hole 54 of the duct plate 50. According to this configuration, the inflow pipe 40a can be temporarily fixed to the duct plate 50, and the brazing material may flow into the joint portion of the inflow pipe 40a and the duct plate 50 through the brazing material pathway 80.
(5) The bottom surface 430 of the protrusion portion 43 of the inflow pipe 40a comes into contact with the outer surface 511 of the outer wall portion 51 of the duct plate 50, and thereby the position of the second portion 42 of the inflow pipe 40a relative to the outer surface 511 of the outer wall portion 51 of the duct plate 50 can be fixed. According to this configuration, the second portion 42 of the inflow pipe 40a can be easily positioned relative to the outer surface 511 of the outer wall portion 51 of the duct plate 50.

### First Modification

Next, the heat exchanger 13 of a first modification example of the first embodiment will be described.

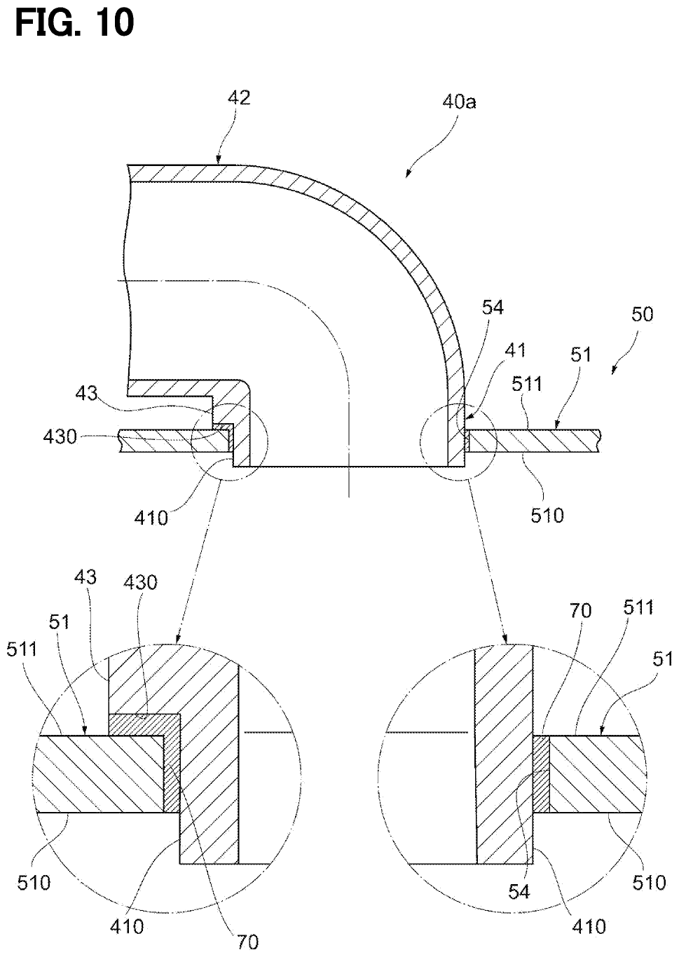

As shown in FIG. 10, in the heat exchanger 13 of the first modification example, the end portion 410 of the inflow pipe 40a is not expanded. According to this configuration also, the inflow pipe 40a can be joined to the duct plate 50 by the brazing material flowing into the brazing material pathway 80, and the gap between the inner side of the insertion hole 54 of the duct plate 50 and the outer circumference of the first portion 41 of the inflow pipe 40a.

### Second Modification

Next, the heat exchanger 13 according to a second modification example of the first embodiment will be described.

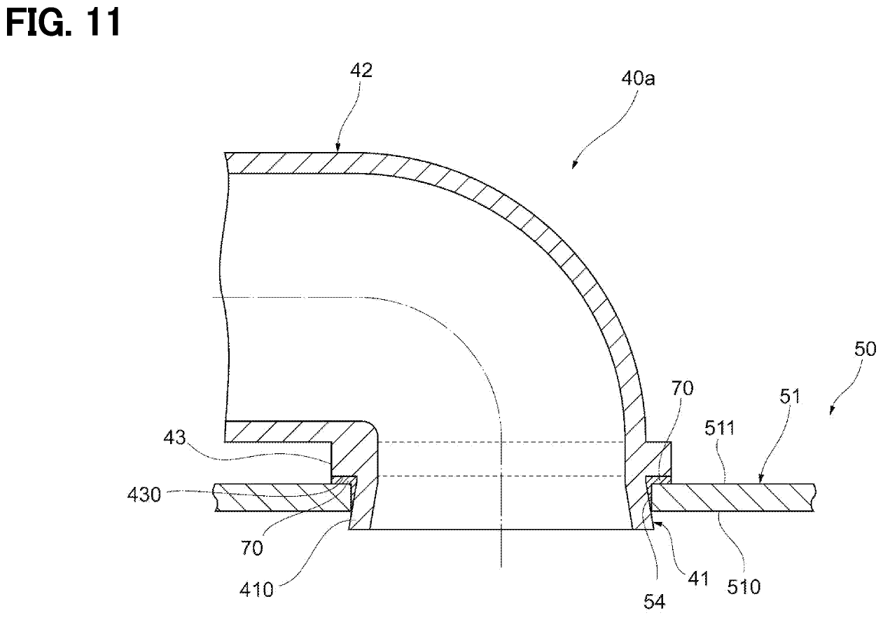

As shown in FIG. 11, in the heat exchanger 13 of the second modification example, the protrusion portion 43 extends all around the circumference of the first portion 41 of the inflow pipe 40a. According to this configuration, since the area of the joint portion of the inflow pipe 40a and the duct plate 50 is increased, the bonding strength between the inflow pipe 40a and the duct plate 50 can be improved.

### Third Modification

Next, the heat exchanger 13 according to a third modification example of the first embodiment will be described.

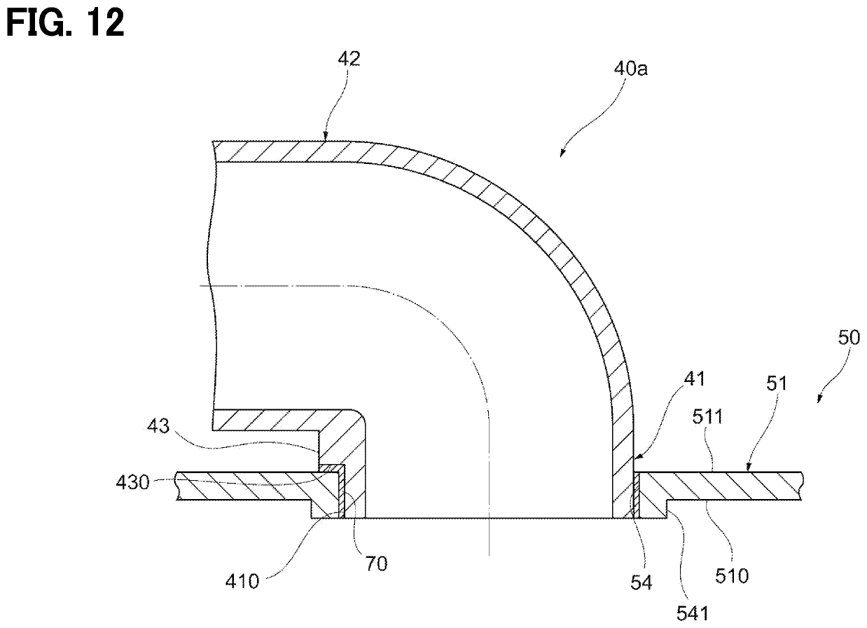

As shown in FIG. 12, in the heat exchanger 13 of the third modification example, the insertion hole 54 of the duct plate 50 has a burring 541 protruding inward of the duct plate 50. According to this configuration also, the structure of the heat exchanger 13 according to the first embodiment can be applied.

### Second Embodiment

Next, the heat exchanger 13 of a second embodiment will be described. Hereinafter, differences from the heat exchanger 13 of the first embodiment will be mainly described.

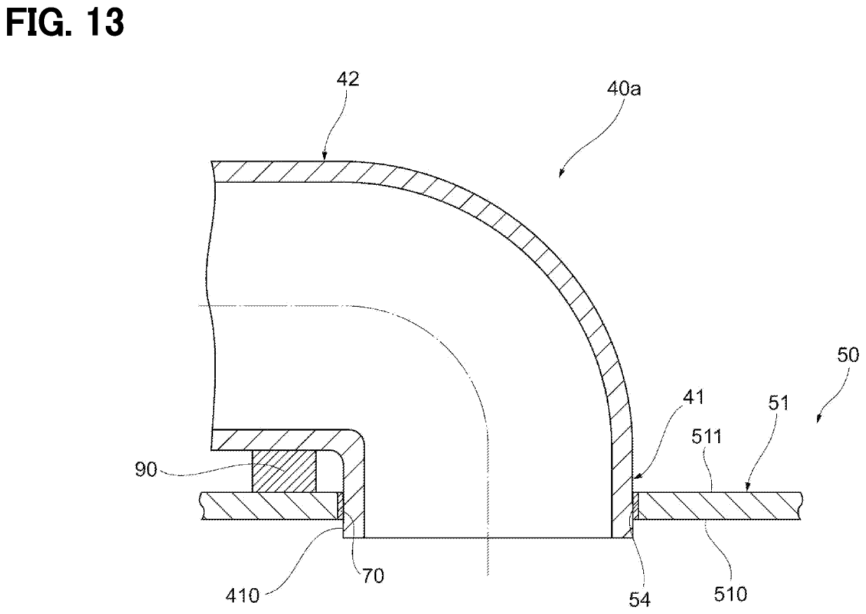

As shown in FIG. 13, in the heat exchanger 13 of the present embodiment, a spacer member 90 is placed between the second portion 42 of the inflow pipe 40a and the outer surface 511 of the outer wall portion 51 of the duct plate 50, in place of the protrusion portion 43 formed on the outer circumference of the first portion 41 of the inflow pipe 40a. The spacer member 90 is a separated member from the inflow pipe 40a and the duct plate 50. The position of the second portion 42 of the inflow pipe 40a relative to the outer surface 511 of the outer wall portion 51 of the duct plate 50 is settled. That is, in the present embodiment, the spacer member 90 works as the fixation member and the positioning member for the inflow pipe 40a.

The heat exchanger 13 of the present embodiment as described above enables to produce the operations and effects (6) as follows in place of the operations and effects (5) as described above.

(6) The second portion 42 of the inflow pipe 40a can be easily positioned relative to the outer surface 511 of the outer wall portion 51 of the duct plate 50 by the spacer member 90. As compared with the case where the inflow pipe 40a has the protrusion portion 43, the structure of the inflow pipe 40a can be simplified. Further, by cladding both sides of the spacer 90, the outer surface 511 and a lower surface of the second portion 42 of the inflow pipe 40a can be bonded by brazing through the spacer member 90, and accordingly the inflow pipe 40a can be strongly brazed to the duct plate 50.

### Third Embodiment

Next, the heat exchanger 13 of a third embodiment will be described. Hereinafter, differences from the heat exchanger 13 of the first embodiment will be described.

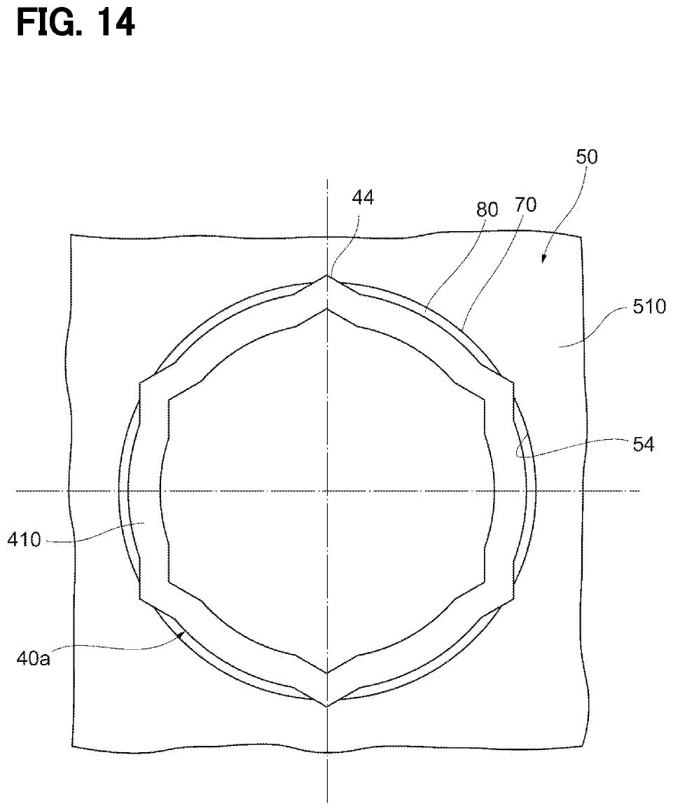

As shown in FIG. 14, a part of the end portion 410 of the inflow pipe 40a according to the present embodiment is expanded outward in a radial direction. According to this, the end portion 410 of the inflow pipe 40a has multiple protrusion portions 44 protruding outward in the radial direction. The protrusion portions 44 are pressed to the inner side of the insertion hole 54 of the duct plate 50.

A gap is defined between the inner side of the insertion hole 54 of the duct plate 50 and a part of the end portion 410 of the inflow pipe 40a at which the protrusion portion 44 is not formed. The gap works as the brazing material pathway 80 into which the brazing material coated on the inner side 510 of the outer wall portion 51 of the duct plate 50 flows. The inflow pipe 40a and the duct plate 50 are joined with each other by the brazing material 70 flowing into the brazing material pathway 80.

Next, a method of joining the inflow pipe 40a to the insertion hole 54 of the duct plate 50 will be described.

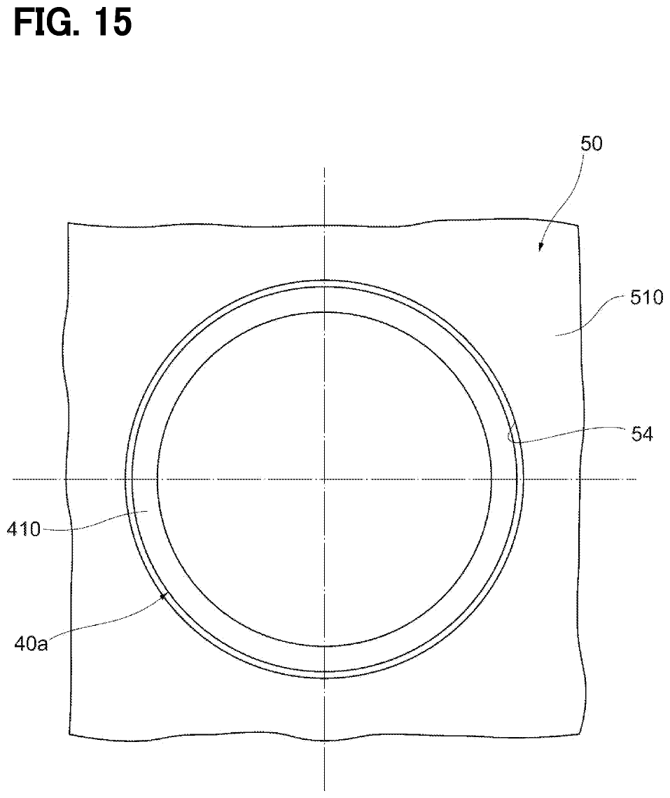

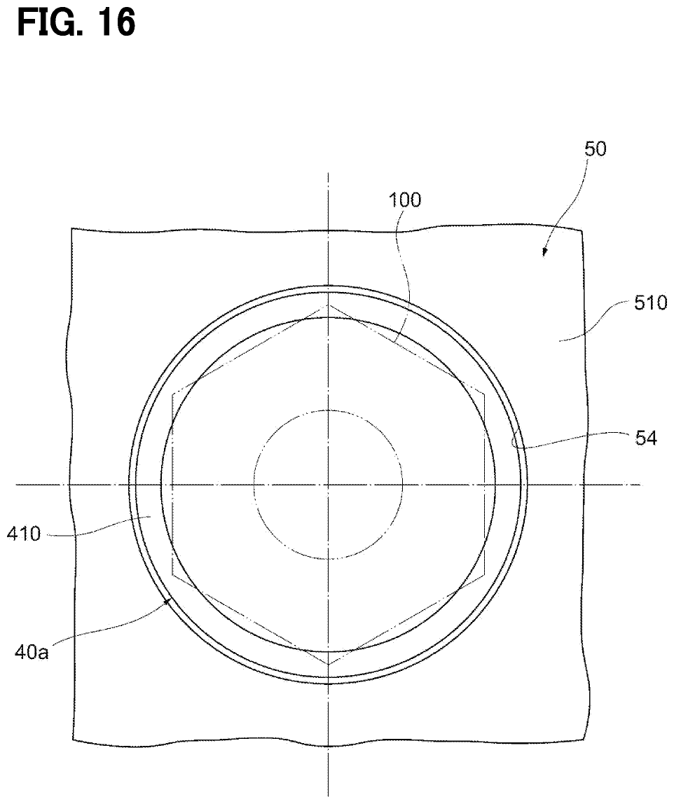

In the assembling step of the heat exchanger 13 of the present embodiment, after the end portion 410 of the inflow pipe 40a is inserted into the insertion hole 54 of the duct plate 50 as shown in FIG. 15, the end portion 410 of the inflow pipe 40a is expanded by a jig 100 indicated by two-dot chain line in FIG. 16. The jig 100 has a polygonal shape. The protrusion portions 44 are formed on the end portion 410 of the inflow pipe 40a by swaging the end portion 410 of the inflow pipe 40a by the jig 100, and thereby the protrusion portions 44 are engaged with the inner side of the insertion hole 54 of the duct plate 50 as shown in FIG. 14. Accordingly, the inflow pipe 40a is temporarily fixed to the duct plate 50. Subsequently, the parts of the heat exchanger 13 are joined together through the bonding step described above.

The heat exchanger 13 of the present embodiment as described above enables to produce the operations and effects (6) as follows in place of the operations and effects (4) as described above.

(6) Since a part of the outer circumference of the inflow pipe 40a is engaged with the inner side of the insertion hole 54 of the duct plate 50, the inflow pipe 40a can be temporarily fixed to the duct plate 50. The brazing material pathway 80 is defined as a gap between the inner side of the insertion hole 54 of the duct plate 50 and a part of the outer circumference of the inflow pipe 40a which is not engaged with the inner side of the insertion hole 54 of the duct plate 50. Accordingly, the brazing material may flow through the brazing material pathway 80 into the joint portion of the inflow pipe 40a and the duct plate 50.

### Other Embodiments

The embodiments described above can be also implemented in the following forms. The number of the brazing material pathways 80 may be changed. The number of the brazing material pathways 80 may be one or more.

The brazing material pathway 80 may be formed on the outer circumference of the inflow pipe 40a instead of the inner side of the insertion hole 54 of the duct plate 50. The brazing material pathway 80 may be formed on the inner side of the insertion hole 54 of the duct plate 50 and on the outer circumference of the inflow pipe 40a.

The first fluid flowing through the duct plate 50 is not limited to the supercharged air, and another fluid may be used as the first fluid. Similarly, the second fluid flowing through the cooling plate 61 is not limited to the coolant, and another fluid may be used as the second fluid.

The present disclosure is not limited to the specific examples described above. The specific examples described above which have been appropriately modified in design by those skilled in the art are also encompassed in the scope of the present disclosure so far as the modified specific examples have the features of the present disclosure. Each element included in each of the specific examples described above, and the placement, condition, shape, and the like of the element are not limited to those illustrated, and can be modified as appropriate. The combinations of the elements in each of the specific examples described above can be changed as appropriate, as long as it is not technically contradictory.

What is claimed is:

1. A heat exchanger comprising:
a plate member that has
a first side coated with a brazing material, and
a second side which is an opposite side of the first side and is not coated with the brazing material;
a fixation member disposed on the second side of the plate member and configured to fix a position of a pipe; and
a brazing material pathway extending through the plate member from the first side to the second side, wherein
the brazing material coated on the plate member spreads into the brazing material pathway,
the pipe is inserted into an insertion hole formed in the plate member,
an entire outer circumference of the pipe is swaged and engaged with an inner side of the insertion hole, and
the brazing material pathway is formed on at least the outer circumference of the pipe or the inner side of the insertion hole.

2. The heat exchanger according to claim 1, wherein
the insertion hole does not have a burring.

3. The heat exchanger according to claim 1, wherein
the insertion hole has a burring that extends from the inner side of the insertion hole to an inside of the plate member.

4. The heat exchanger according to claim 1, wherein
the pipe has
a first portion extending from the insertion hole in a direction perpendicular to an outer surface of an outer wall portion of the plate member, and
a second portion extending from an end of the first portion in parallel to the outer surface of the outer wall portion of the plate member, and
the fixation member is a positioning member configured to fix the position of the second portion of the pipe relative to the outer surface of the outer wall portion of the plate member, the positioning member being configured to fix the pipe to the plate member.

5. The heat exchanger according to claim 4, wherein
the positioning member is a protrusion portion protruding from an outer circumference of the first portion of the pipe, and
the protrusion portion is in contact with the outer surface of the outer wall portion of the plate member to fix the position of the second portion of the pipe relative to the outer surface of the outer wall portion of the plate member.

6. The heat exchanger according to claim 4, wherein
the positioning member is a spacer member that is a separated member separated from the pipe and the plate member, and
the spacer member is sandwiched between the second portion of the pipe and the outer surface of the outer wall portion of the plate member.
